(19) United States
(12) Patent Application Publication
(10) Pub. No.: US 2010/0218920 A1
(43) Pub. Date: Sep. 2, 2010

(54) System And Method For Airflow Dividers For Use With Cooling Systems For An Equipment Enclosure

(75) Inventors: Pasi Jukka Vaananen, Waltham, MA (US); Stephen A. Hauser, Carlisle, MA (US); George Paul Zemke, Chandler, AZ (US)

Correspondence Address: HARNESS, DICKEY & PIERCE, P.L.C., P.O. BOX 828, BLOOMFIELD HILLS, MI, 48303, US

(73) Assignee: EMERSON NETWORK POWER - EMBEDDED COMPUTING, INC., Madison, WI (US)

(21) Appl. No.: 12/580,414

(22) Filed: Oct. 16, 2009

Related U.S. Application Data
(60) Provisional application No. 61/196,436, filed on Oct. 17, 2008.

(51) Int. Cl. F28F 13/06; B23P 15/26

(52) U.S. Cl. 165/126; 29/890.035

(57) ABSTRACT

A cooling system that has a fan having a plurality of fan blades disposed in a housing, with the fan having an input side and an exhaust side. A flow divider component may be disposed parallel to an axial center of the fan and positioned adjacent to the housing of the fan, and adjacent to one of the input side or the exhaust side. The flow divider may further project away from the fan blades for channeling an air flow created by the fan blades.

### CROSS REFERENCE TO RELATED APPLICATIONS

The present application claims priority from U.S. Provisional patent application Ser. No. 61/196,436, filed Oct. 17, 2008, the entire contents of which are hereby incorporated by reference.

### FIELD

The present disclosure relates to systems used for cooling enclosures, and more particularly to a system and method for dividing and guiding air flow being used to cool an electronics equipment enclosure.

### BACKGROUND

The statements in this section merely provide background information related to the present disclosure and may not constitute prior art.

There is a growing interest in maximizing the efficiency of cooling systems used to generate a cooling air flow through electronic equipment enclosures. Maximizing the cooling system efficiency is important to minimize energy costs associated with operating the cooling system.

Many electronic equipment enclosures incorporate a plurality of fans positioned adjacently to one another to either draw air into an enclosure (i.e., a “push” configuration) or to exhaust air out from the enclosure (i.e., a “pull” configuration). Some equipment enclosures use both a “push” type cooling system at one end of the enclosure and a “pull” type cooling system at the other end of the enclosure.

With such cooling systems, the fan inlet and exhaust air flows are complex and highly dependent on the fan surroundings, as well as on the specific impeller or blade geometry of the fan. Accordingly, there is an interest in maximizing the flow efficiency of such fans and to ensure that adjacently positioned fans are not disturbing each other by creating air flows that generate unwanted air flow turbulence and uneven air flow.

### SUMMARY

In one aspect the present disclosure relates to a cooling system. The cooling system may comprise a fan having a plurality of fan blades disposed in a housing, with the fan having an input side and an exhaust side. A flow divider component may be disposed parallel to an axial center of the fan and positioned adjacent to the housing of the fan, and adjacent to one of the input side or the exhaust side. The flow divider may further project away from the fan blades for channeling an air flow created by the fan blades.

In another aspect the present disclosure may comprise a cooling system for an electronics enclosure in which the system includes first and second fans each having a plurality of fan blades disposed within a respective housing. The fans may each have an input side and an exhaust side. A plurality of flow divider components may be disposed parallel to axial centers of the fans and positioned between the fans, and adjacent to the input and exhaust sides of the fans, to project away from the fan blades. The flow divider components may channel air flows created by the fan blades along longitudinal axes extending through an axial center of each of the fans.

In still another aspect the present disclosure may relate to a method for forming a cooling system that involves providing a first fan having a first housing, providing a second fan having a second housing, and disposing the fans adjacent to one another. A flow divider component may be arranged between the fans so that the flow divider component extends generally parallel to a direction of air flow through the fans, the flow divider restricting intermixing of air flows generated by the fans.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a rear perspective view of a fan cooling system in accordance with one embodiment of the present disclosure that makes use of a plurality of air flow divider panels on both the inlet and exhaust sides of the fans used with the system;

FIG. 2 is a front perspective view of the fan cooling system of FIG. 1 even more clearly illustrating the air flow divider panels used on the exhaust sides of the fans of the cooling system;

FIG. 3 is a front view of one of the fans;

FIG. 4 is a side view of one fan of FIG. 3 illustrating the different lengths that the air flow divider panels may take on the inlet and exhaust sides of the fan with rectangular or wedge shaped dividers;

FIG. 5 is a side view of an alternative form of the air flow divider panel having a rectangular shape;

FIG. 6 is a side view of an alternative form of the air flow divider panel having an elliptical shape;

FIG. 7 is a side view of an alternative form of the air flow divider panel having a semi-circular shape; and

FIG. 8 is a side view of an alternative form of the air flow divider panel having an arrow head shape.

### DETAILED DESCRIPTION

The following description is merely exemplary in nature and is not intended to limit the present disclosure, application, or uses. It should be understood that throughout the drawings, corresponding reference numerals indicate like or corresponding parts and features.

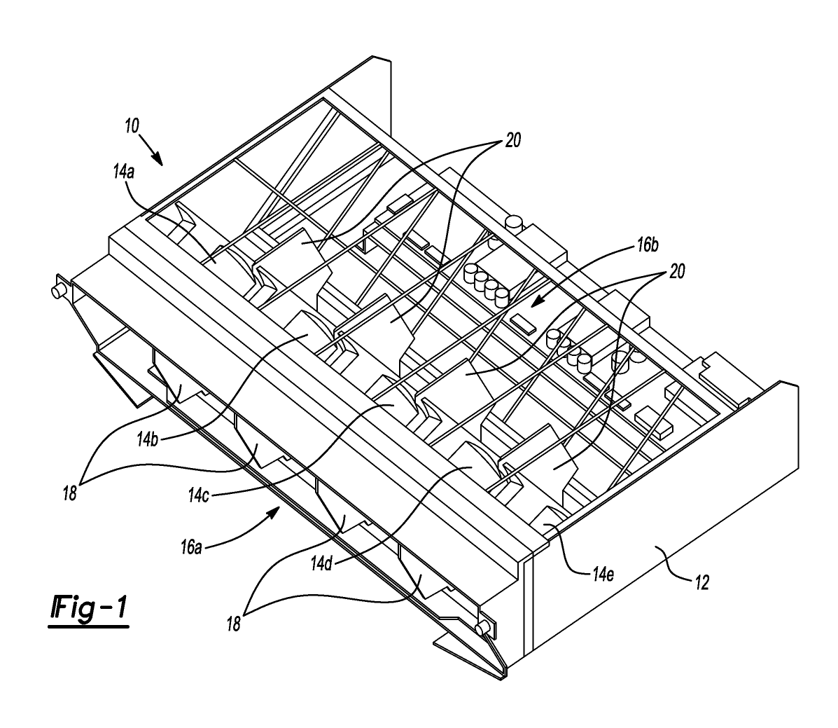

Referring to FIG. 1 there is shown a cooling system 10 in accordance with one embodiment of the present disclosure. In this example the system 10 comprises an enclosure or chassis 12 that may be used with an AdvancedTCA specification shelf system to either “push” a cooling air flow into the Advanced TCA shelf system, or “pull” (i.e., exhaust) air outwardly from an interior area of the shelf system. Also, a pair of the cooling systems 10 could be employed together with an AdvancedTCA shelf system, one being disposed at one end of the shelf system, for example at a bottom area to force a cooling air flow into the shelf system, and the other at an opposite end of the shelf system, for example a top end, to exhaust air out from the interior of the shelf system. Also, while the cooling system 10 is especially well suited for use with AdvancedTCA shelf systems, the system 10 could readily be employed to cool any type of enclosure or chassis, and is therefore not limited to use only with electronic components or only with electronic equipment enclosures.

The cooling system 10 in this example includes five fans 14a-14e supported within the chassis 12. However, it will be appreciated that the cooling system 10 is not limited to use with only five fans. The principles of the present disclosure are applicable to cooling systems employing from one fan to virtually any number of adjacently positioned fans, either in single rows, single columns or with a uniform or non-uniform configured grid of rows and columns of fans. The specific configuration and number of fans used will depend primarily on the cooling requirements of the electronic equipment being cooled and the configuration of the chassis supporting the equipment.

The cooling system 10 of FIG. 1 includes air flow divider components, in this example components in the form of air flow divider panels 18 and 20, with the divider panels 18 being arranged between adjacent fans 14 on an inlet side 16a of each fan 14 and the divider panels 20 being arranged between adjacent ones of the fans on an exhaust side 16b of each fan. The air flow divider panels 18 and 20 help to restrict the areas adjacent each of the fans 14 from which air may be drawn on the inlet sides 16a of the fans 14 to thus inhibit intermixing and turbulence at the inlet sides of the fans 14. Similarly the flow dividers 20 located on the exhaust sides 16b of the fans 14 inhibit intermixing and turbulence that would otherwise be created from the air flows generated by the fans 14 as a result of the fans being positioned closely adjacent one another.

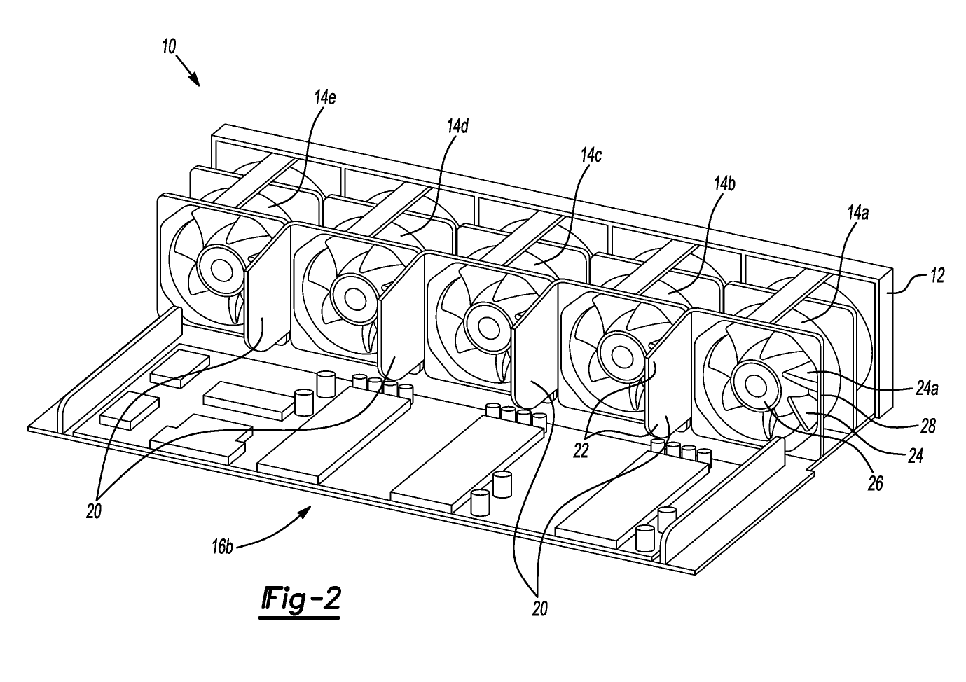

Referring to FIG. 2, the flow divider panels 20 on the exhaust sides 16b of the fans 14 can be seen in greater detail. The flow divider panels 18 and 20 in this example are of identical construction, so the following description will be limited to the construction of divider panels 20 with the understanding that the construction of the divider panels 18 are identical thereto. However, it will be appreciated that all the flow divider panels 18 need not necessarily be of identical construction. Thus, the precise size and shape of the flow divider panels 18 could be varied slightly or significantly to meet the specific air flow needs of a given application. Similarly, the size and shape of the flow divider panels 20 could be varied from one to another to meet the specific air flow needs of a particular application.

Each fan 14 has fan an impeller 24 having a plurality of blades 24a that is driven by a motor 26. The motor 26 rotates the impeller 24 and the blades 24a generate an air flow through an axial center of the fan 14. Each fan 14 further has a housing 28 within which the motor 26 is supported. Each flow divider panel 20 may be formed by a panel or plate of rigid material, for example steel, aluminium, plastic, composites, etc. The principle requirement is that the flow divider panel 20 be relatively rigid so that it cannot flex towards or away from its adjacent fan 14 while the fan is operating. The flow divider panel 20 may have tapering edges 22. Forming or providing the flow divider panels 18 or 20 with the tapering edges 22 provides the benefit of reducing any potential mechanical interference issues with other components or portions of an enclosure in which the chassis 12 is secured. Also, while the flow divider panels 18 and 20 in this example are identically constructed, it is entirely possible that the flow divider panels 18 could be constructed with a shape and/or with dimensions that differ from the shape of the flow divider panels 20.

With further reference to FIG. 2, each flow divider panel 20 may be disposed between the housings 28 of two adjacently positioned fans 14 such that it extends generally parallel to the axial centerlines of its two adjacent fans 14. The flow divider panel 20 is further arranged to extend away from its adjacent fans 14. Each flow divider panel 20 may be secured to a portion of one or both of its adjacent fan housings 28, or it may be fixedly secured to any other fixed structure of the chassis 12 as long as it is positioned between its two adjacent fans 14 and held securely therebetween.

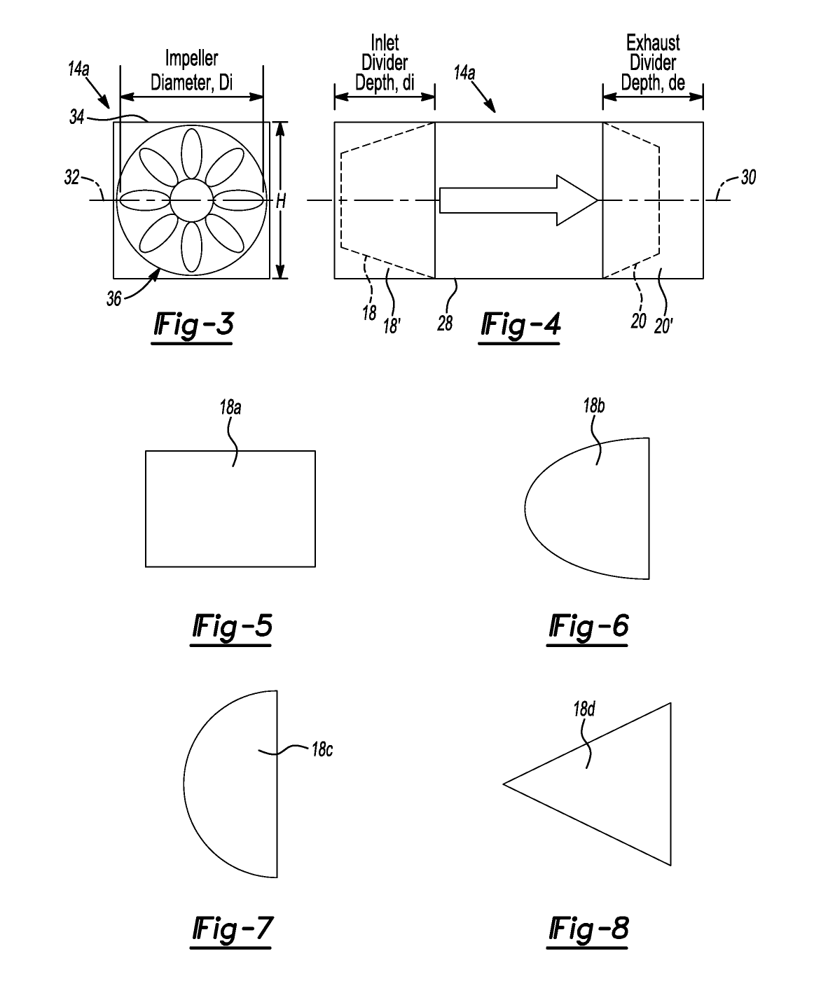

Referring to FIGS. 3 and 4, fan 14a will be referenced in explaining the geometry and configuration of the air flow divider panels 18 and 20. Again, the fans 14a-14e are all identical in construction in this example, but they need not be. In FIG. 3, fan 14a will be understood to have a diameter “Di” and a height “H”.

In FIG. 4 air flow divider panels 18 and 20 are shown positioned on the inlet side 16a and exhaust side 16b, respectively, of the fan 14a. In this example the air flow divider panels 18 and 20 are both formed as wedge shaped dividers. However, alternative constructions, such as divider panels 18′ and 20′, could also be employed. The divider panels 18′ and 20′ in this example form vertically oriented rectangles.

Referring further to FIG. 4, the air flow divider panels 18 and 20 preferably each have a height equal to height H and are arranged along a longitudinal centerline 30 of the fan 14a. The inlet side air flow divider panel 18 may have a depth “di” (i.e., length) while the exhaust side divider panel 20 may have a depth “de” (i.e., length). The depths di and de are each preferably about 0.5-1.0 times the diameter Di. However, benefits in preventing intermixing of adjacent air flows can be experienced with panel depths di and de that are less than 0.5 times the diameter Di. Alternatively, the depths di and/or de may be greater than 1.0 times the diameter Di, providing that interference or clearance issues do not result with other structural components in the vicinity of the fans 14a-14e. The air flow divider panels 18 and 20 may have depths that are the same or different to meet the needs of specific applications and/or space limitations present around the fans 14. While the height of each of the divider panels 18 and 20 is preferably equal to the height “H” of the housing 28 of the fan 14a, benefits may be realized even if the height of each divider panel 18 and 20 is less than the fan housing 28 height. Still further, the height of the divider panels 18 and/or 20 may be greater than the height “H” of the fan housing 28. Also, the divider panels 18 and 20 need not necessarily all have the same height, but could have different heights to suit the needs of a specific implementation. Those skilled in the art of enclosure air flow management will recognize that the divider panel 18 and 20 shapes can be modified to fit the mechanical constraints of the available enclosure space envelope to allow the elimination of mechanical interference with other structures. Thus, both the shape and size of each divider panel 18 and 20 can be selected to meet the needs of a specific implementation.

As described above, the air flow divider panels 18 and 20 help to improve the efficiency of the fans 14 by reducing intermixing of the air flows drawn in, or exhausted by, the fans 14, as well as by reducing turbulence in the air flows being drawn into or exiting from the fans 14. In practice, the intake and exhaust air flows created by each fan 14 are complex and highly dependent on the fan's surroundings, as well as on the specific blade geometry of the fan 14. Due to the circular structure of the blades 24a of each fan 14, the separation distance between the blade tips of two adjacent fans is smallest along the centerline 32 (FIG. 3) of the fans, so the corresponding fan-to-fan air flow interference in both fan inlet and exhaust sides is expected to be largest in this area, and smallest in the top area 34 and bottom area 36 of each of the fans 14, assuming a single fan row configuration.

In a conventional cooling system where a set of fans are closely spaced next to one another, the inlet and exhaust air flows from adjacent fans can cause interference between the fans. This can lead to reduced performance due to increased turbulence and uneven air flow. In essence, the air flows from adjacent fans can be thought of as “competing” with one another. This is due in part because inlet side air flow patterns from each fan create low pressure regions around the fan's perimeter. This effectively pulls air flow from all directions, including directions that are not aligned close to the axial center of the fan. Thus, in a conventional cooling system, when two fans are placed in close proximity, at their inlet (i.e., intake) sides, the fans will each be pulling air from the volume around its periphery, but the volume between the fans will be shared by the two fans. This is what causes interference between the two air flows being generated by the two adjacent fans, and thus reduces performance for both adjacently positioned fans.

The flow divider panels 18 provide the benefit of effectively restricting the air flow volume available to a specific fan 14 as it pulls air through its housing 28 on its inlet side 16a. This serves to create air flow streams that enter each fan's 14 housing 28 along paths that are more closely aligned with the axial centerline 30 of each fan.

On the exhaust sides of a conventional cooling system with adjacently placed fans, the air flows generated by the fans will not be closely along the axial centerline of each fan, but rather will radiate out from each fan along a radial/helical pattern that diverges away from the axial centreline of the fan. Thus, when two fans are placed in close proximity to each other, the exhaust flows from the two fans 14 will be partially “against” each other and will become partially intermixed. This leads to increased turbulence in the exhaust air flows and a decrease in fan performance. The exhaust side air flow divider panels 20 of the present disclosure help to reduce this interference by constraining the air flow exiting each fan housing 28 so that the exhaust air flow flows along a flow path that is more closely aligned with the axial centerline 30 of the fan 14.

While the fans 14a-14e have been shown arranged in a single horizontal row, it will be appreciated that the air flow divider panels 18 and 20 may be employed with fans that are arranged vertically or even in a grid of fans having both rows and columns.

FIGS. 5, 6, 7 and 8 illustrate, without limitation, other possible variations of the shape of the divider panels 18 and 20. FIG. 5 shows a flow divider panel 18a having a generally rectangular shape. FIG. 6 shows a flow divider panel 18b having a generally elliptical shape. FIG. 7 shows a flow divider panel 18c having a generally semi-circular shape. And FIG. 8 shows a flow divider panel 18d having a generally triangular shape. Any of the shapes illustrated in FIGS. 5-8 could be employed for the flow divider panels 20 as well. Various other shapes could just as easily be employed to tailor the flow divider panels 18 and 20 to the air flow requirements of a given system, to suit space restrictions within an equipment enclosure or within the vicinity of the fans 14, or to accommodate any other limitations of a system.

While various embodiments have been described, those skilled in the art will recognize modifications or variations which might be made without departing from the present disclosure. The examples illustrate the various embodiments and are not intended to limit the present disclosure. Therefore, the description and claims should be interpreted liberally with only such limitation as is necessary in view of the pertinent prior art.

What is claimed is:

1. A cooling system comprising:
a fan having a plurality of fan blades disposed within a housing, said fan having an input side and an exhaust side; and
a flow divider component disposed parallel to an axial center of said fan and positioned adjacent to the housing of the fan, and adjacent to one of said input side or said exhaust side; and
said flow divider further projecting away from said fan blades for channeling an air flow created by said fan blades.

2. The cooling system of claim 1, wherein said channeling an air flow comprises using a plurality of said flow divider components arranged adjacent to both said input side and said exhaust side, to restrict areas adjacent to said input side and said exhaust side from which air flows can be drawn from or directed towards by said fan blades.

3. The cooling system of claim 1, wherein said flow divider component comprises an air flow divider panel secured adjacent to said housing and projecting generally perpendicular to a plane in which said fan blades extend.

4. The cooling system of claim 3, wherein said air flow divider panel comprises a generally square shape.

5. The cooling system of claim 3, wherein said air flow divider panel comprises a generally rectangular shape.

6. The cooling system of claim 3, wherein said air flow divider panel comprises a generally semi-circular shape.

7. The cooling system of claim 3, wherein said air flow divider panel comprises a generally triangular shape.

8. The cooling system of claim 3, wherein said air flow divider panel comprises a generally elliptical shape.

9. The cooling system of claim 1, wherein said flow divider component has a height at one edge thereof that is approximately equal to a diameter of said fan.

10. The cooling system of claim 1, wherein said flow divider component has a depth that is between 0.5 times to 1.0 times that of a diameter of the fan.

11. A cooling system for an electronics enclosure, the system comprising:
first and second fans each having a plurality of fan blades disposed within a respective housing, said fans each having an input side and an exhaust side; and
a plurality of flow divider components disposed parallel to axial centers of said fans and positioned between said fans, and adjacent to said input and exhaust sides of said fans, to project away from said fan blades for channeling air flows created by said fan blades along longitudinal axes extending through an axial center of each of said fans.

12. The cooling system of claim 11, wherein the plurality of flow divider components comprises a plurality of air flow divider panels.

13. The cooling system of claim 12, wherein the plurality of air flow divider panels extends perpendicularly from a plane within which said fan blades lie.

14. The cooling system of claim 12, wherein an edge of one of said air flow divider panels has a height that is approximately equal to a diameter of one of said fans.

15. The cooling system of claim 12, wherein a depth of at least one of the air flow divider panels is between about 0.5 times to 1.0 times a diameter of one of said fans.

16. The cooling system of claim 12, wherein a shape of at least one of said air flow divider panels comprises one of:
a generally square shape;
a generally rectangular shape;
a generally elliptical shape;
a generally semicircular shape; and
a generally triangular shape.

17. A method for forming a cooling system, comprising:
providing a first fan having a first housing;
providing a second fan having a second housing;
disposing said fans adjacent to one another; and
arranging a flow divider component between said fans so that said flow divider component extends generally parallel to a direction of air flow through said fans, said flow divider restricting intermixing of air flows generated by said fans.

18. The method of claim 17, wherein said arranging a flow divider component between said fans comprises arranging an air flow divider panel between said fans.

19. The method of claim 17, wherein said arranging a flow divider component between said fans comprises arranging fist and second air flow divider panels adjacent input and output sides of said fans, respectively, such that said first and second air flow divider panels extend from said input and output sides and generally parallel to an axis of flow of said fans.

20. The method of claim 18, wherein said arranging an air flow divider panel between said fans comprises arranging an air flow divider panel having a shape comprising:
a generally square shape;
a generally rectangular shape;
a generally elliptical shape;
a generally semi-circular shape; and
a generally triangular shape.
